(19) United States
(12) Patent Application Publication
(10) Pub. No.: US 2013/0011762 A1
(43) Pub. Date: Jan. 10, 2013

(54) DIRECT OXIDATION FUEL CELL

(75) Inventor: Hiroaki Matsuda, Kadoma-shi (JP)

(73) Assignee: PANASONIC CORPORATION, Kadoma-shi, Osaka (JP)

(21) Appl. No.: 13/636,110

(22) PCT Filed: Mar. 8, 2011
(86) PCT No.: PCT/JP2011/001347

§ 371 Date: Sep. 19, 2012

(30) Foreign Application Priority Data
Mar. 25, 2010 (JP) 2010-070823

(51) Int. Cl. H01M 8/04; H01M 8/24

(52) U.S. Cl. 429/457

(57) ABSTRACT

Disclosed is a direct oxidation fuel cell including at least one cell, each cell comprising a stack of: a membrane electrode assembly including an anode, a cathode, and an electrolyte membrane interposed between the anode and the cathode; an anode-side separator facing the anode; and a cathode-side separator facing the cathode. The anode-side separator has a serpentine fuel flow channel on a surface thereof facing the anode, a fuel is supplied from upstream of the fuel flow channel, and the serpentine fuel flow channel has a cross-sectional area that increases stepwise from upstream toward downstream of the fuel flow channel.

### TECHNICAL FIELD

The present invention relates to a direct oxidation fuel cell, and specifically relates to an improvement of a fuel flow channel of an anode-side separator.

### BACKGROUND ART

As the performance of mobile devices such as cellular phones, notebook personal computers, and digital cameras improves, solid polymer fuel cells including solid polymer electrolyte membranes are expected to be used as power sources for such devices. Among solid polymer fuel cells (hereinafter simply referred to as “fuel cells”), direct oxidation fuel cells, which operate on a liquid fuel such as methanol directly supplied to the anode, are suitable for size and weight reduction, and are being developed as power sources for mobile devices and portable power generators.

Fuel cells include membrane electrode assemblies (MEAs). An MEA is composed of an electrolyte membrane, an anode (fuel electrode) bonded to one surface of the electrolyte membrane, and a cathode (air electrode) bonded to the other surface thereof. The anode comprises an anode catalyst layer and an anode diffusion layer, and the cathode comprises a cathode catalyst layer and a cathode diffusion layer. The MEA is sandwiched between a pair of separators, forming a cell. The anode-side separator has a fuel flow channel for supplying a fuel such as hydrogen gas or methanol to the anode. The cathode-side separator has an oxidant flow channel for supplying an oxidant such as oxygen gas or air to the cathode.

There are some problems to be solved in direct oxidation fuel cells.

One of them is a problem related to power generation characteristics and power generation efficiency. There are several causes of deterioration in power generation characteristics and power generation efficiency, and one of them is fuel crossover. When methanol is used as a fuel, the fuel crossover is called methanol crossover (MCO). MCO is a phenomenon in which methanol supplied as the fuel to the anode permeates through the electrolyte membrane and reaches the cathode.

It should be noted that hydrogen gas is difficult to dissolve in water, as compared with methanol. Thus, in a polymer electrolyte fuel cell using hydrogen gas as a fuel, it is unlikely to happen that hydrogen gas permeates through the electrolyte membrane and reaches the cathode. In short, fuel crossover is a phenomenon peculiar to the fuel being methanol or an aqueous methanol solution.

MCO lowers the cathode potential, and thus decreases the power output. Moreover, the methanol having permeated through the electrolyte membrane and reached the cathode reacts with oxidant, and the oxidant is excessively consumed. As a result, downstream of the oxidant flow channel, the oxidant supply becomes insufficient, and the power output is decreased. At the same time, the fuel is also uselessly consumed, and the power generation efficiency is also decreased.

In order to reduce MCO, it is considered effective to decrease the amount of methanol reaching the electrolyte membrane from the anode catalyst layer, and for that purpose, it is considered effective to decrease the amount of methanol to be supplied to the anode catalyst layer. However, if the amount of methanol to be supplied is decreased throughout the anode, the methanol supply becomes insufficient downstream of the fuel flow channel, and as a result, the power output is decreased due to increase in concentration overvoltage.

Although not intending to reduce MCO, Patent Literature 1 proposes that, in a solid polymer fuel cell using hydrogen gas as a fuel, the cross-sectional area of the fuel flow channel of the anode-side separator be increased from upstream toward downstream along the flow direction of the fuel gas, so that the product ρ/v of a density ρ of the fuel gas and an inverse of a flow rate v of the fuel gas can be constant from the inlet to the outlet of the fuel flow channel. In Patent Literature 1, the width or depth of the fuel flow channel of the anode-side separator is continuously varied from upstream toward downstream along the flow direction of the fuel gas.

Likewise, although not intending to reduce MCO, Patent Literature 2 proposes that, in a solid polymer fuel cell using hydrogen gas as a fuel, the width of the fuel flow channel of the anode-side separator be increased stepwise, from the fuel inlet toward the fuel outlet of the fuel flow channel, so that the removability of droplets generated in the fuel flow channel can be improved. In Patent Literature 2, the fuel flow channel comprises many straight channels arranged in parallel with each other (parallel flow channel), and the width of the channel is increased stepwise at a straight portion of the channel.

### CITATION LIST

### Patent Literature

[PTL 1] Japanese Laid-Open Patent Publication No. 2005-317426

[PTL 2] Japanese Laid-Open Patent Publication No. 2009-064772

### SUMMARY OF INVENTION

### Technical Problem

The present invention intends to provide a direct oxidation fuel cell exhibiting excellent power generation characteristics and power generation efficiency, by reducing the methanol crossover upstream of the fuel flow channel, while ensuring a sufficient supply of methanol downstream of the fuel flow channel, thereby to prevent a decrease in power output.

### Solution to Problem

One aspect of the present invention is a direct oxidation fuel cell including at least one cell, each cell comprising a stack of: a membrane electrode assembly including an anode, a cathode, and an electrolyte membrane interposed between the anode and the cathode; an anode-side separator facing the anode; and a cathode-side separator facing the cathode. The anode-side separator has a serpentine fuel flow channel on a surface thereof facing the anode, a fuel is supplied from upstream of the fuel flow channel, and the serpentine fuel flow channel has a cross-sectional area that increases stepwise from upstream toward downstream of the fuel flow channel. The direct oxidation fuel cell of the present invention uses methanol or an aqueous methanol solution as the fuel. The cross-sectional area preferably increases at a turn portion of the serpentine fuel flow channel.

The serpentine fuel flow channel preferably comprises fuel flow paths having different cross-sectional shapes, the fuel flow paths being allowed to communicate with each other by arranging side by side at least two anode-side separator units provided with the fuel flow paths having different cross-sectional shapes. At this time, the fuel flow path of each of the anode-side separator units preferably has a major region constituting a major part of the fuel flow path and having a constant cross-sectional shape, and a communication region provided continuously from at least one end of the major region. Of the anode-side separator units adjacent to each other, it is preferable that the cross-sectional areas of the major regions increase stepwise from upstream toward downstream of the fuel flow channel, and the communication regions connected to each other have an identical cross-sectional shape.

Of the anode-side separator units adjacent to each other, it is more preferable that the communication regions connected to each other are located at a turn portion of the serpentine fuel flow channel.

The cross-sectional shape of the fuel flow channel is preferably constant from a starting end of the fuel flow channel, from upstream toward downstream thereof, to an extent of one-fifth to one-half of an overall length of the fuel flow channel.

In one preferred embodiment of the present invention, at least part of the fuel flow channel may comprise two or three independent serpentine flow channels arranged in parallel with each other.

The concentration of methanol in the fuel is preferably 3 mol/L to 8 mol/L.

### Advantageous Effects of Invention

According to the present invention, MCO can be reduced upstream of the fuel flow channel, while a sufficient amount of methanol can be supplied downstream of the fuel flow channel. The decrease in power output caused by MCO and the decrease in power output caused by insufficient supply of methanol can be both suppressed, and therefore, the power generation characteristics and power generation efficiency of the fuel cell can be improved remarkably.

In addition, by increasing stepwise the cross-sectional area of the fuel flow channel of the anode-side separator, it is possible to simplify the process of forming a flow channel and reduce the time and costs for producing the anode-side separator. Moreover, by forming the fuel flow channel in a serpentine shape, even in a direct oxidation fuel cell using a liquid fuel, which does not flow through a flow channel so smoothly, it is possible to supply a liquid fuel stably throughout the cell.

While the novel features of the invention are set forth particularly in the appended claims, the invention, both as to organization and content, will be better understood and appreciated, along with other objects and features thereof, from the following detailed description taken in conjunction with the drawings.

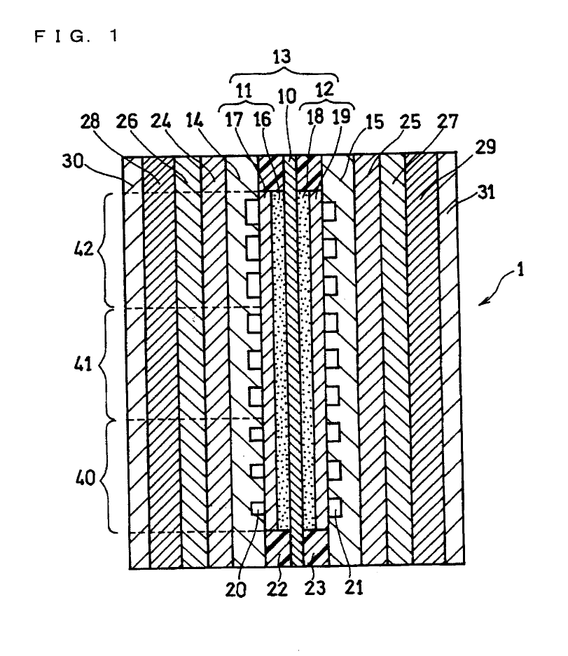

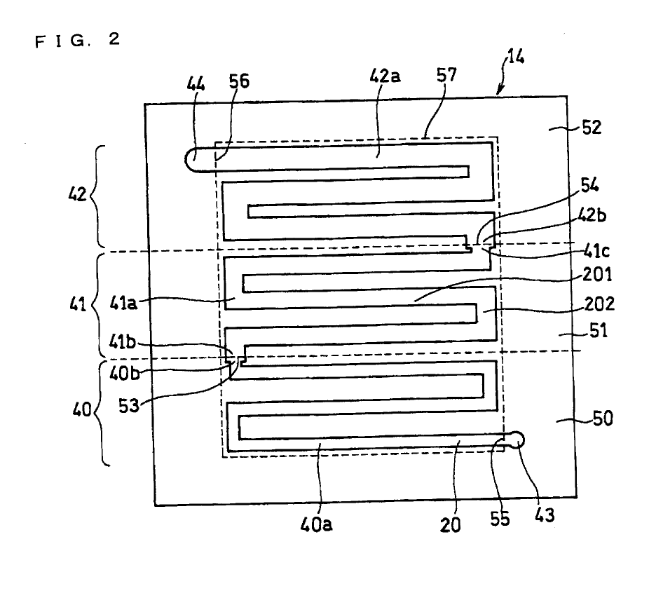

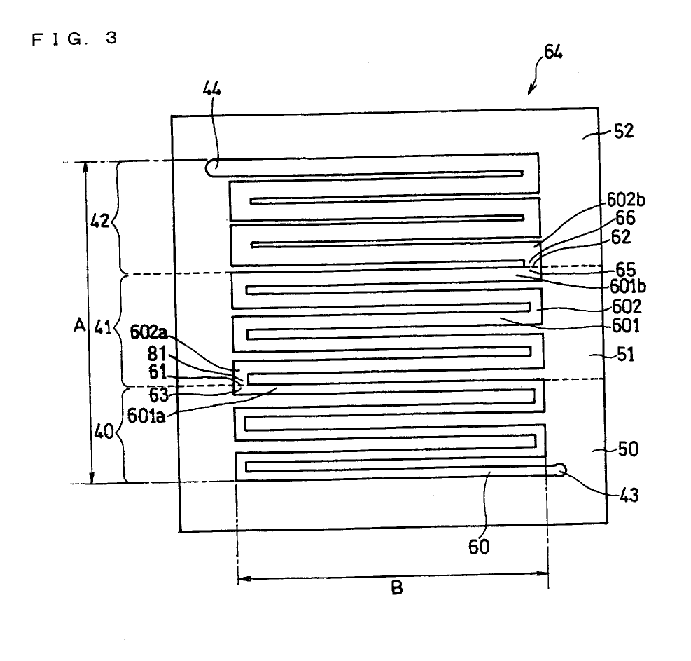

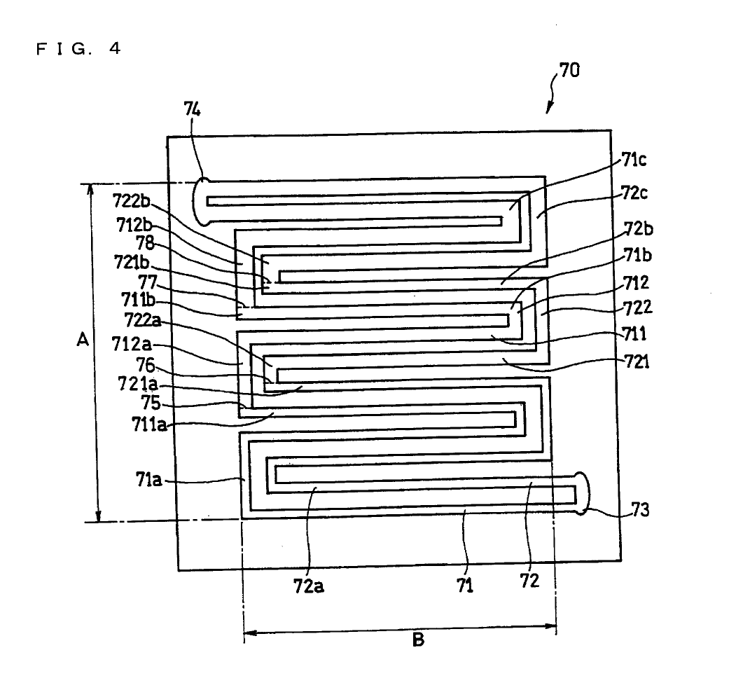

### BRIEF DESCRIPTION OF DRAWINGS

[FIG. 1] A schematic longitudinal cross-sectional view of a direct oxidation fuel cell according to one embodiment of the present invention.

[FIG. 2] A top view of the surface provided with a fuel flow channel of an anode-side separator included in the direct oxidation fuel cell illustrated in FIG. 1, as seen in the direction normal to the surface.

[FIG. 3] A top view of the surface provided with a fuel flow channel of an anode-side separator included in a direct oxidation fuel cell according to another embodiment of the present invention, as seen in the direction normal to the surface.

[FIG. 4] A top view of the surface provided with a fuel flow channel of an anode-side separator included in a direct oxidation fuel cell according to yet another embodiment of the present invention, as seen in the direction normal to the surface.

### DESCRIPTION OF EMBODIMENTS

A direct oxidation fuel cell of the present invention includes at least one cell, each cell comprising a stack of: a membrane electrode assembly including an anode, a cathode, and an electrolyte membrane interposed between the anode and the cathode; an anode-side separator facing the anode; and a cathode-side separator facing the cathode. The anode-side separator has a serpentine fuel flow channel on a surface thereof facing the anode. A fuel is supplied from upstream of the fuel flow channel, and the cross-sectional area of the fuel flow channel increases stepwise from upstream toward downstream of the fuel flow channel. The fuel flow channel is preferably formed on the anode-side separator in such a form that allows fuel to be supplied sufficiently throughout the anode.

FIG. 1 is a schematic longitudinal cross-sectional view of a direct oxidation fuel cell according to one embodiment of the present invention. FIG. 2 is a top view of the surface provided with a fuel flow channel of an anode-side separator included in the direct oxidation fuel cell in FIG. 1, as seen in the direction normal to the surface.

A fuel cell 1 of FIG. 1 has a membrane electrode assembly (MEA) 13 including an anode 11, a cathode 12, and an electrolyte membrane 10 interposed between the anode 11 and the cathode 12. A gasket 22 is fitted to one side of the membrane electrode assembly 13 so as to seal the anode 11, and a gasket 23 is fitted to the other side so as to seal the cathode 12. The membrane electrode assembly 13 is sandwiched between an anode-side separator 14 and a cathode-side separator 15. The anode-side separator 14 is in contact with the anode 11, and the cathode-side separator 15 is in contact with the cathode 12. The anode-side separator 14 has a fuel flow channel 20 for supplying a fuel to the anode 11. The cathode-side separator 15 has an oxidant flow channel 21 for supplying an oxidant to the cathode 12.

As illustrated in FIG. 2, the anode-side separator 14 is provided with the serpentine fuel flow channel 20. The fuel flow channel 20 has a plurality of straight portions 201 and a plurality of turn portions 202 connecting two adjacent straight portions 201. The straight portions 201 may be arranged in parallel with each other or in a layout similar thereto. One end of the fuel flow channel 20 communicates with a fuel inlet 43, and the other end of the flow channel 20 communicates with a fuel outlet 44. The fuel flows from the fuel inlet 43, through the flow channel 20, to the fuel outlet 44. The cross-sectional area of the flow channel 20 increases stepwise from upstream toward downstream along the flow direction of the fuel. In FIG. 2, the width of the fuel flow channel is changed to change the cross-sectional area of the fuel flow channel.

The cross-sectional area of the fuel flow channel 20 is preferably changed, for example, in two to ten steps, and more preferably changed in three to five steps. When the cross-sectional area of the fuel flow channel is increased stepwise, as compared with, for example, when it is increased continuously, the time and costs for producing the anode-side separator is less likely to increase. Further, in changing the cross-sectional area, the shape of the cross section of the flow channel and the ratio of changing of the cross-sectional area can be easily controlled.

The serpentine fuel flow channel 20 preferably comprises fuel flow paths having different cross-sectional shapes, the fuel flow paths being allowed to communicate with each other by arranging side by side at least two anode-side separator units provided with the fuel flow paths having different cross-sectional shapes. By using at least two anode-side separator units to form the fuel flow channel 20, it is possible to easily form the anode-side separator 14 having the fuel flow channel 20 whose cross-sectional area increases stepwise. Specifically, for example, when the fuel flow channel 20 is formed by grinding or cutting the surface facing the anode of the anode-side separator, the fuel flow channel 20 can be simply formed by using one grinding tool or one cutting tool for one anode-side separator unit. Therefore, each anode-side separator unit can be produced efficiently.

Preferably, the fuel flow channel 20 has major regions constituting a major part thereof as a whole and each having a constant cross-sectional shape, and communication regions each provided continuously from at least one end of the major region. Preferably, of the anode-side separator units adjacent to each other, the cross-sectional areas of the major regions increase stepwise from upstream toward downstream of the fuel flow channel, and the communication regions connected to each other have an identical cross-sectional shape.

Detailed description is given below with reference to FIG. 2. FIG. 2 shows a configuration in which the anode-side separator 14 is composed of three units. The “cross-sectional shape of the flow channel” herein refers to a shape of the flow channel on a cross section perpendicular to the fuel flow direction.

The anode-side separator 14 in FIG. 2 is composed of three units arranged side by side: an upstream unit 50, a midstream unit 51, and a downstream unit 52. The upstream unit 50 includes the fuel inlet 43 and an upstream section 40 of the fuel flow channel 20, the midstream unit 51 includes a midstream section 41 of the fuel flow channel 20, and the downstream unit 52 includes a downstream section 42 of the fuel flow channel 20 and the fuel outlet 44.

The upstream section 40 extends from a starting end of the fuel flow channel 20 and has a major region 40a having a constant cross-sectional shape. The major region 40a constitutes a major part of the upstream section 40. The midstream section 41 has a major region 41a constituting a major part thereof. The major region 41a comprises a flow path portion having a cross-sectional area larger than that of the major region 40a of the upstream unit 50. The downstream section 42 has a major region 42a constituting a major part thereof. The major region 42a includes a terminating end of the fuel flow channel 20, and comprises a flow path portion having a cross-sectional area larger than that of the major region 41a of the midstream unit 51. The upstream section 40 further has a communication region 40b provided continuously from the downstream-side end of the major region 40a. The midstream section 41 further has upstream- and downstream-side communication regions 41b and 41c provided continuously from the upstream- and downstream-side ends of the major region 41a, respectively. The downstream section 42 has a communication region 42b provided continuously from the upstream-side end of the major region 42a.

The “starting end of the fuel flow channel” herein refers to a point of the fuel flow channel at which the fuel having entered from the fuel inlet 43 is regarded as first contacting a power generation area 57 as it flows through the fuel flow channel 20. For example, in FIG. 2, an entrance 55 of the fuel to the power generation area 57 is the starting end. The “terminating end of the fuel flow channel” herein refers to a point of the fuel flow channel at which the fuel is regarded as last contacting the power generation area 57 as it flows through the fuel flow channel 20. For example, in FIG. 2, an exit 56 of the fuel from the power generation area 57 is the terminating end. The power generation area 57 is an area where the anode 11 of the MEA is situated.

The major region 40a in the upstream section 40 is allowed to communicate with the major region 41a in the midstream section 41 by connecting the communication region 40b in the upstream section 40 to the upstream-side communication region 41b in the midstream section 41 at a communication point 53. Likewise, the major region 41a in the midstream section 41 is allowed to communicate with the major region 42a in the downstream section 42 by connecting the downstream-side communication region 41c in the midstream section 41 to the communication region 42b in the downstream section 42 at a communication point 54.

At the communication point 53, the cross-sectional shape of the communication region 40b in the upstream section 40 is identical with that of the upstream-side communication region 41b in the midstream section 41. At the communication point 54, the cross-sectional shape of the downstream-side communication region 41c in the midstream section 41 is identical with that of the communication region 42b in the downstream section 42. Specifically, the cross-sectional shape of the flow channel in at least one of the communication region 40b and the upstream-side communication region 41b in the upstream and midstream sections 40 and 41 is different from the cross-sectional shape of the flow channel in the major region in that section. Likewise, the cross-sectional shape of the flow channel in at least one of the downstream-side communication region 41c and the communication region 42b in the midstream and downstream sections 41 and 42 is different from the cross-sectional shape of the flow channel in the major region in that section. In FIG. 2, the communication region 40b in the upstream section 40 is a region having a cross-sectional shape identical with that of the upstream-side communication region 41b in the midstream section 41. The downstream-side communication region 41c in the midstream section 41 is a region having a cross-sectional shape identical with that of the communication region 42b in the downstream section 42.

As described above, by using at least two separator units having major regions with different cross-sectional areas, and arranging the separator units side by side such that the cross-sectional areas of the major regions increase from upstream toward downstream, the cross-sectional area of the fuel flow channel can be increased stepwise from upstream toward downstream thereof.

In FIG. 2, the communication point 53 between the upstream section 40 and the midstream section 41, and the communication point 54 between the midstream section 41 and the downstream section 42 are located at different turn portions. The cross-sectional area of the fuel flow channel increases near the communication point 53 and near the communication point 54.

By providing the anode-side separator with a serpentine fuel flow channel, and increasing the cross-sectional area of the fuel flow channel from upstream toward downstream of the fuel flow channel, the fuel is allowed to flow through the fuel flow channel at a higher rate upstream and at a lower rate downstream. By allowing the fuel to flow faster on the upstream side of the fuel flow channel where MCO tends to increase due to high fuel concentration, it is possible to reduce the amount of fuel to be diffused into the anode catalyst layer, and thus reduce MCO. Simultaneously, by allowing the fuel to flow slower on the downstream side of the fuel flow channel where the concentration overvoltage tends to increase due to low fuel concentration, it is possible to increase the amount of fuel to be diffused into the anode catalyst layer, and thus reduce the concentration overvoltage. It should be noted here that, on the downstream side of the fuel flow channel, the concentration of the fuel flowing therethrough is low, and MCO does not increase so much.

In short, by providing the anode-side separator with a serpentine fuel flow channel whose cross-sectional area increases stepwise from upstream toward downstream thereof, MCO can be reduced upstream of the fuel flow channel, while methanol can be supplied sufficiently downstream of the fuel flow channel. Therefore, according to the present invention, the decrease in power output caused by MCO and the decrease in power output caused by insufficient supply of methanol can be both suppressed, and as a result, the power generation characteristics and power generation efficiency of the fuel cell can be improved remarkably.

In FIG. 2, each separator unit has one major region.

Patent Literature 2 discloses a technique regarding a parallel fuel flow channel. According to the findings of the present inventor, when serving as a fuel flow channel in a direct oxidation fuel cell, a serpentine flow channel can provide more excellent power generation characteristics than a parallel flow channel. This is presumably for the following reason. In a direct oxidation fuel cell, the fuel is liquid and flows less easily through the fuel flow channel than a hydrogen gas fuel. Therefore, when the fuel flow channel is composed of many flow channels arranged in parallel with each other, if resistance is caused in one of the flow channels by, for example, generation of CO₂ bubbles, it is likely to occur that the fuel preferentially flows through the other flow channels, and the fuel is not supplied to the fuel channel where resistance is caused.

On the other hand, in the serpentine fuel flow channel 20, the direction of fuel flow changes drastically, causing the fuel flow to tend to be slowed at the turn portions 202. Moreover, CO₂ bubbles and fuel droplets tend to accumulate at the turn portions 202, which may obstacle the smooth flow of the fuel. In order to allow the fuel to flow more smoothly, the cross-sectional area of the fuel flow channel 20 is preferably increased at the turn portion 202. Specifically, the portion where the cross-sectional area of the fuel flow channel of the anode-side separator increases is preferably located at the turn portion 202. When the portion where the cross-sectional area of the fuel flow channel increases is located at the turn portion 202, the fuel flow becomes less stagnant. As such, the decrease in power generation output due to fuel deficiency on the downstream side of the fuel flow channel can be suppressed.

The portion where the cross-sectional area of the fuel flow channel increases may be located at any position of the turn portion 202, as long as it is located within the turn portion 202. For example, as illustrated in FIG. 2, the portion where the cross-sectional area of the fuel flow channel increases may be located at a position other than a junction of the turn portion 202 and the straight portion 201. Alternatively, as illustrated in FIG. 3, the portion where the cross-sectional area of the fuel flow channel increases may be located at a junction of the turn portion and the straight portion. In FIG. 3, the same component as in FIG. 2 are denoted by the same reference numerals, and in FIG. 3 also, the cross-sectional area of the fuel flow channel is changed by changing the width of the fuel flow channel.

In an anode-side separator 64 in FIG. 3, a fuel flow channel 60 has a plurality of straight portions 601 and a plurality of turn portions 602 connecting two adjacent straight portions 601. A communication region 63 located downstream of the upstream section 40 of the fuel flow channel 60 is connected at a communication point 61, to an upstream-side communication region 81 in the midstream section 41. At the communication point 61, a downstream-side end of a straight portion 601a which is the most downstream straight portion in the upstream section 40 is connected to an upstream-side end of a turn portion 602a which is the most upstream turn portion in the midstream section 41.

Likewise, a downstream-side communication region 65 in the midstream section 41 of the fuel flow channel 60 is connected at a communication point 62, to a communication region 66 located upstream of the downstream section 42. At the communication point 62, a downstream-side end of a straight portion 601b which is the most downstream straight portion in the midstream section 41 is connected to an upstream-side end of a turn portion 602a which is the most upstream turn portion in the downstream section 42.

As shown in FIG. 3, in the case where a portion where the cross-sectional area of the fuel flow channel increases, i.e., a junction of the turn portion and the straight portion, is located at a communication point between the flow paths provided on two adjacent separator units, only the cross-sectional shapes of the ends of the flow path portions constituting the communication regions may be changed. Therefore, the fuel flow channel can be formed easily.

The number of separator units composing the anode-side separator may be selected as appropriate, according to the number of steps in which the cross-sectional area of the fuel flow channel is increased.

Although a configuration in which the anode-side separator is composed of two or more separator units is described with reference to FIGS. 2 and 3, the anode-side separator may be composed of one rectangular anode-side separator on which the fuel flow channel as illustrated in FIG. 2 or 3 is formed.

The fuel flow channel provided on the anode-side separator may comprise one serpentine flow channel, from the fuel inlet to the fuel outlet. Alternatively, at least part of the fuel flow channel may comprise two or three independent serpentine flow channels arranged in parallel with each other. One example thereof is illustrated in FIG. 4. In FIG. 4, the fuel flow channel provided on the anode-side separator comprises two independent serpentine flow channels arranged in parallel with each other. In FIG. 4 also, the cross-sectional area of the fuel flow channel is changed by changing the width of the fuel flow channel.

An anode-side separator 70 of FIG. 4 is provided with a fuel flow channel comprising two independent serpentine flow channels 71 and 72 arranged in parallel with each other. The flow channel 71 has a plurality of straight portions 711 and a plurality of turn portions 712 connecting two adjacent straight portions 711. Likewise, the flow channel 72 has a plurality of straight portions 721 and a plurality of turn portions 722 connecting two adjacent straight portions 721. One end of the flow channel 71 communicates with a fuel inlet 73, and the other end thereof communicates with a fuel outlet 74. Likewise, one end of the flow channel 72 communicates with the fuel inlet 73, and the other end thereof communicates with the fuel outlet 74. The fuel flows from the fuel inlet 73 through the flow channels 71 and 72 to the fuel outlet 74.

In each of the flow channels 71 and 72 of FIG. 4, the cross-sectional area of the flow channel increases in three steps from upstream toward downstream thereof. For example, in the flow channel 71, an upstream section 71a extends from the starting end of the flow channel 71 near the fuel inlet 73 to the downstream-side end of a straight portion 711a. A midstream section 71b extends from the upstream-side end of a turn portion 712a to the downstream-side end of a straight portion 711b. A downstream section 71c extends from the upstream-side end of a turn portion 712b to the terminating end of the flow channel 71 near the fuel outlet 74. In short, in the flow channel 71, the upstream section 71a communicates with the midstream section 71b at a communication point 75, and the midstream section 71b communicates with the downstream section 71c at a communication point 77.

Likewise, in the flow channel 72, an upstream section 72a extends from the starting end of the flow channel 72 near the fuel inlet 73 to the downstream-side end of a straight portion 721a. A midstream section 72b extends from the upstream-side end of a turn portion 722a to the downstream-side end of a straight portion 721b. A downstream section 72c extends from the upstream-side end of a turn portion 722b to the terminating end of the flow channel 72 near the fuel outlet 74. In short, in the flow channel 72, the upstream section 72a communicates with the midstream section 72b at a communication point 76, and the midstream section 72b communicates with the downstream section 72c at a communication point 78. In FIG. 4, the connection points 75 to 78 are hypothetically shown by dotted line.

It should be noted that even in a direct oxidation fuel cell using a liquid fuel, which does not flow through a flow channel so smoothly, as long as the fuel flow channel comprises up to two or three flow channels arranged in parallel, unstable fuel supply as often seen in the case of a parallel flow channel is unlikely to occur. Even if one or two of the three parallel flow channels temporarily fails to allow the fuel to flow therethrough, the fuel is supplied up to at least one-third of the whole area of the anode. The fuel cell can operate as long as it is in this state. However, when four or more independent flow channels are arranged in parallel, the number of flow channels which may possibly fail to allow the fuel therethrough increases, and the fuel supply tends to be unstable. Moreover, the area where the fuel is to be supplied may decrease to one-fourth or less. When this happens, the fuel cell may become difficult to operate. When the fuel flow channel comprises four or more independent serpentine flow channels arranged in parallel, such a fuel flow channel cannot be regarded as a serpentine flow channel any more, and is more like a parallel flow channel.

The anode-side separator of FIG. 4 may be composed of two or more separator units. Alternatively, the anode-side separator of FIG. 4 may be composed of one rectangular separator on which a fuel flow channel as illustrated in FIG. 4 is formed.

In the case where the anode-side separator of FIG. 4 is composed of two or more separator units, the extent of the portion of the flow channel to be formed on each unit is selected as appropriate according to, for example, the ease of formation.

The cross-sectional shape of the fuel flow channel is preferably constant from the starting end of the fuel flow channel, from upstream toward downstream thereof, to an extent of one-fifth to one-half of the overall length of the fuel flow channel. For example, when the anode-side separator is composed of two or more separator units, it is preferable that in the fuel flow path of the most upstream anode-side separator unit, the major region extends from the starting end of the fuel flow channel, to an extent of one-fifth to one-half of the overall length of the fuel flow channel. Particularly in this extent of area, the fuel crossover tends to increase. Therefore, by decreasing the fuel crossover in this extent of area, the power generation characteristics and power generation efficiency can be further improved.

When the fuel flow channel comprises one flow channel as illustrated in FIGS. 2 and 3, the portions of the flow channel having different cross-sectional areas may have the same length or different lengths. In FIGS. 2 and 3, the portions of the flow channel in the upstream, midstream, and downstream sections have the same length.

When the fuel flow channel has two or more independent flow channels as illustrated in FIG. 4, the flow channels may have the same length or different lengths. In each of the flow channels, the portions of the flow channel having different cross-sectional areas may have the same length or different lengths. Preferably, the two or more independent flow channels have the same length, and in each of the flow channels, the portions of the flow channel having different cross-sectional areas have the same length. By configuring as above, the flow channels will have the same pressure loss, and the fuel will tend to equally enter the flow channels. In FIG. 4, the flow channels 71 and 72 have the same length. The upstream sections 71a and 72a of the flow channels 71 and 72 have the same length, the midstream sections 71b and 72b of the flow channels 71 and 72 have the same length, and the downstream sections 71c and 72c of the flow channels 71 and 72 have the same length.

The portion of the flow channel being disposed most downstream of the fuel flow channel and having the largest cross-sectional area preferably extends from the terminating end of the fuel flow channel toward upstream of the fuel flow channel, to an extent of one-third to one-fifth of the overall length of the fuel flow channel. Particularly in this extent of area, concentration overvoltage due to a drop in methanol concentration of the fuel tends to increase. Therefore, by allowing the fuel to flow at a lower rate in this extent of area, and thereby increasing the fuel supply to the anode catalyst layer, the power generation characteristics of the fuel cell can be further improved.

The cross-sectional shape of the fuel flow channel is usually rectangle or square. A fuel flow channel having such a cross-sectional shape is easy to produce, and such a cross-sectional shape is easy to control. In order to change the cross-sectional area of the fuel flow channel, it is preferable to change either the width or depth of the fuel flow channel, or both. At this time, it is preferable that the depth of the fuel flow channel is constant from upstream toward downstream of the fuel flow channel, and the width of the fuel flow channel is increased stepwise from upstream toward downstream of the fuel flow channel. Increasing only the width of the fuel flow channel stepwise from upstream toward downstream of the fuel flow channel is preferable because both the fuel flow rate and the fuel diffusibility into the anode can be controlled easily and properly.

The ratio Wl/Wu of the cross-sectional area Wl of the most downstream fuel flow channel portion (the portion having the largest cross-sectional area) to the cross-sectional area Wu of the most upstream fuel flow channel portion (the portion having the smallest cross-sectional area) is preferably 1.5 to 10, and more preferably 2 to 5. When the cross-sectional area ratio Wl/Wu is within the above range, the fuel crossover can be sufficiently decreased upstream of the fuel flow, while the fuel can be sufficiently supplied downstream of the fuel flow. As a result, the power generation characteristics and power generation efficiency of the fuel cell can be further improved.

When the cross-sectional area of the fuel flow channel is increased in three or more steps, that is, when at least one midstream section is interposed between the upstream and downstream sections of the fuel flow channel, the cross-sectional area(s) of the fuel flow channel in the midstream section(s) (Wm₁, Wm₂, . . . , Wm, sequentially from upstream) are selected, as appropriate, according to the cross-sectional area Wu of the fuel flow channel in the upstream section and the cross-sectional area Wl of the fuel flow channel of the downstream section. For example, Wm₁, Wm₂, . . . , Wm may be selected so that the cross-sectional area ratios Wm₁/Wu, Wm₂/Wm₁, . . . , Wl/Wm between two adjacent fuel flow channel portions communicating with each other and having different cross-sectional areas become nearly equal to each other. Alternatively, for example, they may be selected so that Wm₂/Wm₁ becomes greater than Wm₁/Wu. The cross-sectional area ratios between two adjacent fuel flow channel portions communicating with each other and having different cross-sectional areas are selected, as appropriate, according to, for example, the characteristics and size of the MEA, and the performance of the fuel pump.

When the fuel cell comprises two or more independent flow channels, in each flow channel, the cross-sectional shape of the flow channel is preferably constant from the starting end of the flow channel, from upstream toward downstream thereof, to an extent of one-fifth to one-half of the overall length of the fuel flow channel. In each flow channel, the flow channel portion being disposed most downstream of the flow channel and having the largest cross-sectional area preferably extends from the terminating end of the flow channel toward upstream of the flow channel, to an extent of one-third to one-fifth of the overall length of the fuel flow channel. Furthermore, in each flow channel, the ratio Wl/Wu of the cross-sectional area Wl of the most downstream flow channel portion to the cross-sectional area Wu of the most upstream flow channel portion is preferably 1.5 to 10, and more preferably 2 to 5.

There is no limitation on the constituent material of the anode-side separator. Preferred examples of the constituent material of the anode-side separator include a carbon material, and a metal material coated with carbon, in view of their excellent electron conductivity and acid resistance, low material permeability, and high processability.

The fuel flow channel on the anode-side separator may be formed by any machining method generally known in the art, for example, by grinding with a tool such as Leutor, press-working with a die, and etching with a laser. The machining method may be selected, as appropriate, according to, for example, the size and shape of the fuel flow channel to be formed.

The cross-sectional area of the fuel flow channel is dependent on the size of MEA, the flow rate of fuel, the capacity of fuel pump, and other factors. Although an appropriate range thereof cannot be unconditionally determined for this reason, an exemplary range thereof is 0.5 to 2 mm in width and 0.5 to 1 mm in depth. When the cross-sectional area of the fuel flow channel is far below the above range, the smooth fuel flow is hindered, which may cause the power generation characteristics to deteriorate. Conversely, when the cross-sectional area of the fuel flow channel is far above the above range, fuel is excessively supplied, particularly upstream of the fuel flow channel, which may increase MCO.

In the present invention, portions other than the points where the cross-sectional area of the fuel flow channel increases have a constant cross-sectional area. However, in each of the portions, the cross-sectional area thereof is not necessarily exactly the same as that of the straight portion, particularly in the turn portion, depending on the machining accuracy of the serpentine flow channel and other reasons. Even in this case, the effect of the present invention is similarly obtained, as long as the cross-sectional area of the fuel flow channel increases stepwise from upstream toward downstream of the fuel flow channel.

The effect obtained by increasing the cross-sectional area of the fuel flow channel stepwise from upstream toward downstream of the fuel flow channel is particularly evident when the fuel is an aqueous methanol solution containing methanol at a concentration of 3 mol/L to 8 mol/L. The higher the methanol concentration of the fuel is, the more MCO increases. Therefore, increasing the methanol concentration to some extent can enhance the effect to suppress MCO obtained by changing the cross-sectional area of the fuel flow channel. Increasing the fuel concentration can reduce the size and weight of the fuel cell system as a whole on one hand, but on the other hand, it may cause MCO to increase. According to the present invention, since MCO can be reduced, it is possible to use an aqueous methanol solution having a methanol concentration which is higher than usual. However, when the methanol concentration of the fuel exceeds 8 mol/L, the amount of MCO becomes so large that the effect of the present invention to reduce MCO might not be obtained sufficiently. By using an aqueous methanol solution having the above-described methanol concentration, the effect to reduce MCO can be properly obtained in the fuel flow channel of the anode-side separator of the present invention.

A methanol-containing fuel can be stored in a predetermined fuel tank. In this case, the fuel can be supplied to the anode using a predetermined fuel pump.

The direct oxidation fuel cell of the present invention is characterized by the anode-side separator, as described above. The components other than the anode-side separator are not particularly limited, and components similar to those as used for the conventional direct oxidation fuel cell can be used. In the following, the components other than the anode-side separator are described with reference to FIG. 1 again.

The cathode 12 includes a cathode catalyst layer 18 in contact with the electrolyte membrane 10 and a cathode diffusion layer 19 in contact with the cathode-side separator 15. The cathode diffusion layer 19 includes, for example, a conductive water-repellent layer in contact with the cathode catalyst layer 18 and a substrate layer in contact with the cathode-side separator 15.

The cathode catalyst layer 18 includes a cathode catalyst and a polymer electrolyte. The cathode catalyst is preferably a noble metal with high catalytic activity such as platinum. Alternatively, the cathode catalyst may be an alloy of platinum and cobalt or the like. The cathode catalyst can be used with or without a support. The support is preferably a carbon material, such as carbon black, since it has excellent electronic conductivity and acid resistance. The polymer electrolyte is preferably a proton conductive material, such as a perfluorosulfonic acid polymer material or a hydrocarbon polymer material. Examples of the perfluorosulfonic acid polymer material include Nafion (registered trademark) and Flemion (registered trademark).

The cathode catalyst layer 18 can be produced, for example, as follows. A cathode catalyst or a supported cathode catalyst, a polymer electrolyte, and a dispersion medium, such as water or an alcohol, are mixed to prepare an ink for forming a cathode catalyst layer. The ink is applied onto a substrate sheet made of PTFE by, for example, doctor blade application or spraying, and dried, to form the cathode catalyst layer 18. The cathode catalyst layer 18 is then transferred onto the electrolyte membrane 10 by, for example, hot pressing.

Alternatively, the cathode catalyst layer 18 may be directly formed on the electrolyte membrane 10, by applying the ink for forming a cathode catalyst layer onto the electrolyte membrane 10, and drying the ink.

The anode 11 includes an anode catalyst layer 16 in contact with the electrolyte membrane 10 and an anode diffusion layer 17 in contact with the anode-side separator 14. The anode diffusion layer 17 includes, for example, a conductive water-repellent layer in contact with the anode catalyst layer 16 and a substrate layer in contact with the anode-side separator 14.

The anode catalyst layer 16 includes an anode catalyst and a polymer electrolyte. The anode catalyst is preferably a noble metal with high catalytic activity such as platinum. Alternatively, for reducing catalyst poisoning by carbon monoxide, the anode catalyst may be a platinum-ruthenium alloy catalyst. The anode catalyst can be used with or without a support. The support for the anode catalyst may be the same carbon material as used for the cathode catalyst. The polymer electrolyte included in the anode catalyst layer 16 may be the same material as used for the cathode catalyst layer 18.

The anode catalyst layer 16 can be formed similarly to the cathode catalyst layer 18.

The conductive water-repellent layers included in the anode and cathode diffusion layers 17 and 19 include a conductive material and a water repellent material. The conductive material included in the conductive water-repellent layers may be any conductive material commonly used in the field of fuel cells. Examples of such material include carbon powders, such as carbon black and flake graphite; and carbon fibers, such as carbon nanotubes and carbon nanofibers. These conductive materials may be used singly or in combination of two or more.

The water repellent material included in the conductive water-repellent layers may be any water repellent material commonly used in the field of fuel cells. Specifically, the water repellent material is preferably, for example, a fluorocarbon resin. The fluorocarbon resin may be any known fluorocarbon resin. Examples thereof include polytetrafluoroethylene (PTFE), tetrafluoroethylene-hexafluoropropylene copolymer (FEP), tetrafluoroethylene-perfluoroalkylvinylether copolymer, tetrafluoroethylene-ethylene copolymer, and polyvinylidene fluoride. Preferable examples among them include PTFE and FEP. These water repellent materials may be used singly or in combination or two or more.

The conductive water-repellent layer is formed on the surface of the substrate layer. The method of forming the conductive water-repellent layer is not particularly limited. For example, a conductive material and a water repellent material are dispersed in a predetermined dispersion medium to prepare a paste for forming a conductive water-repellent layer. The paste for forming a conductive water-repellent layer is applied onto one side of a substrate layer by doctor blade application or spraying and then dried. In this way, a conductive water-repellent layer can be formed on the surface of the substrate layer.

The substrate layer is made of a conductive porous material. The conductive porous material may be any conductive porous material commonly used in the field of fuel cells. A preferable conductive porous material is a highly electron-conductive material having good fuel or oxidant diffusibility. Examples of such material include carbon paper, carbon cloth, and carbon non-woven fabric. These porous materials may contain a water repellent material in order to improve the diffusion of fuel and removal of product water. The water repellent material may be the same material as the water repellent material included in the conductive water-repellent layer. The method of adding a water repellent material to a porous material is not particularly limited. For example, a porous material is immersed in a dispersion of a water repellent material and dried, whereby a substrate layer comprising the porous material containing the water repellent material can be obtained.

The electrolyte membrane 10 may be, for example, any proton conductive polymer membrane conventionally used in the art. Preferable examples thereof include a perfluorosulfonic acid polymer membrane and a hydrocarbon polymer membrane. A perfluorosulfonic acid polymer membrane is exemplified by Nafion (registered trademark) membrane or Flemion (registered trademark) membrane. A hydrocarbon polymer membrane is exemplified by sulfonated polyetherketone membrane or sulfonated polyimide membrane. Among them, a hydrocarbon polymer membrane is preferably used as the electrolyte membrane 10. Using a hydrocarbon polymer membrane can prevent the sulfonate groups from forming a cluster structure, and thus make the electrolyte membrane 10 less fuel permeable. This can further reduce the fuel crossover. The thickness of the electrolyte membrane 10 is preferably 20 μm to 150 μm.

The direct oxidation fuel cell of FIG. 1 can be produced, for example, by the following method. The membrane electrode assembly 13 is produced by bonding the anode 11 to one surface of the electrolyte membrane 10 and the cathode 12 to the other surface by, for example, hot pressing. The membrane electrode assembly 13 is then sandwiched between the anode-side separator 14 and the cathode-side separator 15. At this time, the gasket 22 is fitted between the electrolyte membrane 10 and the anode-side separator 14 to seal the anode 11 of the membrane electrode assembly 13 with the gasket 22, and the gasket 23 is fitted between the electrolyte membrane 10 and the cathode-side separator 15 to seal the cathode 12 with the gasket 23. Thereafter, the anode-side separator 14 and the cathode-side separator 15 are sandwiched between current collector plates 24 and 25, insulator plates 26 and 27, and end plates 28 and 29, respectively, and they are clamped. Subsequently, heaters 30 and 31 for temperature control are laminated to the outsides of the end plates 28 and 29. In this way, the fuel cell 1 of FIG. 1 can be produced.

The present invention is hereinafter described specifically by way of Examples, but the present invention is not to be construed as being limited to the following Examples.

### Example 1

(a) Preparation of Anode-Side Separator

An anode-side separator was prepared by forming a fuel flow channel as illustrated in FIG. 3 on a surface facing the anode of one carbon plate. Specifically, one serpentine flow channel was formed as the fuel flow channel. The serpentine flow channel had fourteen turn portions and fifteen straight portions. The cross-sectional shape of the fuel flow channel was rectangular, and the depth of the fuel flow channel was constant at 1.0 mm from the starting end to the terminating end of the fuel flow channel.

The portion extending from the starting end to the 5^{th} straight portion was regarded as the upstream section of the fuel flow channel, and the width of the flow channel therein was set to 1.0 mm. The portion extending from the upstream-side end of the 5^{th} turn portion to the 10^{th} straight portion was regarded as the midstream section, and the width of the flow channel therein was set to 1.5 mm. The portion extending from the upstream-side end of the 10^{th} turn portion to the flow channel terminating end was regarded as the downstream section, and the width of the flow channel therein was set to 2.0 mm. The perpendicular distance from the center of the width of one straight portion to the center of the width of the straight portion adjacent thereto was constant at 3.0 mm. The width of the rib between straight portions was narrowed in three steps to offset the three-step increase of the width of the flow channel. The “width of the straight portion” herein refers to a length of the straight portion perpendicular to the flow direction of the fuel flowing in the straight portion.

The total length A from the outside end of the 1^{st} straight portion parallel to the fuel flow direction to the outside end of the 15^{th} straight portion parallel to the fuel flow direction was 43.5 mm. The lengths (perpendicular distances) B from the outside end of one turn portion to the outside end of the next turn portion were all 45 mm.

(b) Formation of Cathode Catalyst Layer

A supported cathode catalyst including a cathode catalyst and a cathode support for supporting the cathode catalyst was prepared. A Pt catalyst was used as the cathode catalyst. A carbon black (trade name: Ketjen black ECP, available from Ketjen Black International Company Ltd.) was used as the catalyst support. The weight ratio of Pt catalyst to the total weight of Pt catalyst and carbon black was 50 wt %.

A dispersion of the supported cathode catalyst in an aqueous isopropanol solution was mixed with a dispersion of Nafion (registered trademark) (5 wt % Nafion solution available from Sigma-Aldrich Japan K.K.) serving as a polymer electrolyte, to prepare an ink for forming a cathode catalyst layer. The ink for forming a cathode catalyst layer was applied onto a polytetrafluoroethylene (PTFE) sheet by doctor blade application, and dried to form a cathode catalyst layer.

(c) Formation of Anode Catalyst Layer

A Pt—Ru alloy catalyst (Pt:Ru=1:1 (atomic ratio)) was used as an anode catalyst. An anode catalyst layer was formed in the same manner as the cathode catalyst layer, except that the anode catalyst was used in place of the cathode catalyst. The weight ratio of Pt—Ru catalyst to the total weight of Pt—Ru catalyst and Ketjen black was 50 wt %.

(d) Preparation of Paste for Forming Conductive Water-Repellent Layer

A dispersion of water repellent material and a conductive material were dispersed and mixed in ion-exchange water to which a predetermined surfactant had been added, to prepare a paste for forming a conductive water-repellent layer. A PTFE dispersion (PTFE content: 60 mass %, available from Sigma-Aldrich Japan K.K.) was used as the dispersion of water-repellent material. Acetylene black (DENKA BLACK, available from Denki Kagaku Kogyo K.K.) was used as the conductive material.

(e) Formation of Substrate Layer

A carbon paper (TGP-H-090, thickness: 270 μm, available from Toray Industries Inc.) was used as the conductive porous material constituting the anode substrate layer of the anode diffusion layer. The carbon paper was immersed in a PTFE dispersion (available from Sigma-Aldrich Japan K.K.) containing PTFE serving as a water repellent material, and dried. In this way, the carbon paper was made water-repellent.

A carbon cloth (AvCarb (registered trademark) 1071HCB, available from Ballard Material Products Inc.) was used as the conductive porous material constituting the cathode substrate layer of the cathode diffusion layer. This carbon cloth was also made water-repellent in the same manner as described above.

(f) Formation of Anode Diffusion Layer and Cathode Diffusion Layer

The paste for forming a conductive water-repellent layer prepared in (d) was applied onto one side of the anode substrate layer formed in (e), and then dried to form an anode diffusion layer. Likewise, the paste for forming a conductive water-repellent layer prepared in (d) was applied onto one side of the cathode substrate layer formed in (e), and then dried to form a cathode diffusion layer.

(g) Production of Membrane Electrode Assembly (MEA)

The cathode catalyst layer formed on the PTFE sheet in (b) was disposed on one side of an electrolyte membrane (trade name: Nafion (registered trademark) 112, available from E.I. Du Pont de Nemours & Co. Inc.), and the anode catalyst layer formed on the PTFE sheet in (c) was disposed on the other side of the electrolyte membrane. At this time, the cathode and anode catalyst layers were disposed such that the surfaces opposite to the surfaces on which the PTFE sheet was provided of the cathode and cathode catalyst layers were in contact with the one and the other sides of the electrolyte membrane, respectively. Thereafter, the cathode catalyst layer and the anode catalyst layer were bonded to the electrolyte membrane by hot pressing, and the PTFE sheets were removed therefrom.

Subsequently, the cathode diffusion layer and the anode diffusion layer were bonded to the cathode catalyst layer and the anode diffusion layer, respectively, by hot pressing. In this way, a membrane electrode assembly (MEA) was produced.

(h) Production of Fuel Cell

A rubber gasket was fitted to each side of the electrolyte membrane exposed at the periphery of the MEA, to cover the whole exposed portion of the electrolyte membrane. Subsequently, the MEA was sandwiched between the anode-side separator prepared in (a) and a cathode-side separator. An oxidant flow channel for supplying an oxidant to the cathode had been formed beforehand on the surface to be in contact with the cathode of the cathode-side separator. The oxidant flow channel was formed in a serpentine shape.

Thereafter, on the outside of each of the anode- and cathode-side separators, a current collector plate, an insulator plate, and an end plate were disposed in this order. The resultant stack was clamped with predetermined clamping means. On the outside of each of the end plates, a heater for temperature adjustment was laminated. In this way, a direct oxidation fuel cell (direct methanol fuel cell) of Example 1 was produced. It is noted that in the following evaluation test, the current collector plates were connected to an electronic load unit.

(i) Evaluation of Power Generation Characteristics

Power was generated as follows. Air was supplied to the cathode of the fuel cell thus obtained, while an aqueous 4 mol/L methanol solution was supplied to the anode. The fuel cell was connected to an electronic load unit, and the current to be generated was set to a constant current of 150 mA/cm² by the electronic load unit.

The temperature of the fuel cell was kept at 60° C., the air utilization rate was set to 50%, and the fuel utilization rate was set to 70%. The power generation time was set to 60 minutes, and the average voltage during the power generation of 60 minutes was determined. The results are shown in Table 1.

The power generation efficiency was determined using the following formula (1):

Power generation efficiency=Current generated/Current generated+Current converted from MCO) (1)

MCO was obtained as follows. The methanol concentration in the effluent from the anode was measured by gas chromatography. Based on the methanol concentration in the aqueous methanol solution supplied to the anode, the concentration (amount) of methanol used for power generation, and the methanol concentration in the effluent obtained as above, the methanol balance at the anode was calculated to obtain MCO. The results are shown in Table 1.

### Example 2

In the preparation of an anode-side separator in Example 1, the portion extending from the fuel flow channel starting end to the 3^{rd} straight portion was regarded as the upstream section of the fuel flow channel, and the width of the flow channel therein was set to 1.0 mm. The portion extending from the upstream-side end of the 3^{rd} turn portion to the 10^{th} straight portion was regarded as the midstream section, and the width of the flow channel therein was set to 1.5 mm. The portion extending from the upstream-side end of the 10^{th} turn portion to the flow channel terminating end was regarded as the downstream section, and the width of the flow channel therein was set to 2.0 mm.

A direct oxidation fuel cell of Example 2 was produced in the same manner as in Example 1, except that the anode-side separator thus prepared was used.

The fuel cell thus produced was evaluated for power generation characteristics in the same manner as in Example 1. The results are shown in Table 1.

### Example 3

In the preparation of an anode-side separator in Example 1, the portion extending from the fuel flow channel starting end to the 7^{th} straight portion was regarded as the upstream section of the fuel flow channel, and the width of the flow channel therein was set to 1.0 mm. The portion extending from the upstream-side end of the 7^{th} turn portion to the 11^{th} straight portion was regarded as the midstream section, and the width of the flow channel therein was set to 1.5 mm. The portion extending from the upstream-side end of the 11^{th} turn portion to the flow channel terminating end was regarded as the downstream section, and the width of the flow channel therein was set to 2.0 mm.

A direct oxidation fuel cell of Example 3 was produced in the same manner as in Example 1, except that the anode-side separator thus prepared was used.

The fuel cell thus produced was evaluated for power generation characteristics in the same manner as in Example 1. The results are shown in Table 1.

### Example 4

In the preparation of an anode-side separator in Example 1, the portion extending from the fuel flow channel starting end to the 3^{rd} straight portion was regarded as the upstream section of the fuel flow channel, and the width of the flow channel therein was set to 1.0 mm. The midstream section was further divided into three sub-sections, which were referred to as, from upstream, a first midstream sub-section, a second midstream sub-section, and a third midstream sub-section. The portion extending from the upstream-side end of the 3^{rd} turn portion to the 6^{th} straight portion was regarded as the first midstream sub-section, and the width of the flow channel therein was set to 1.2 mm. The portion extending from the upstream-side end of the 6^{th} turn portion to the 9^{th} straight portion was regarded as the second midstream sub-section, and the width of the flow channel therein was set to 1.5 mm. The portion extending from the upstream-side end of the 9^{th} turn portion to the 12^{th} straight portion was regarded as the third midstream sub-section, and the width of the flow channel therein was set to 1.8 mm. The portion extending from the upstream-side end of the 12^{th} turn portion to the flow channel terminating end was regarded as the downstream section, and the width of the flow channel therein was set to 2.0 mm.

A direct oxidation fuel cell of Example 4 was produced in the same manner as in Example 1, except that the anode-side separator thus prepared was used.

The fuel cell thus produced was evaluated for power generation characteristics in the same manner as in Example 1. The results are shown in Table 1.

### Example 5

An anode-side separator was prepared by forming a fuel flow channel as illustrated in FIG. 4 comprising two independent serpentine flow channels 71 and 72 arranged in parallel with each other from the starting end to the terminating end, on a surface facing the anode of one carbon plate. The resultant fuel flow channel has fourteen straight portions and six turn portions. Each of the six turn portions includes two adjacent turns of the flow channels 71 and 72. In the resultant fuel flow channel, for example, the most upstream straight portion, which is a portion of the flow channel 71, turns at the 1^{st} turn portion (counting from upstream), and continues to the 4^{th} straight portion (counting from upstream). Simultaneously, the 2^{nd} straight portion (counting from upstream), which is a portion of the flow channel 72, turns at the 1^{st} turn portion (counting from upstream), and continues to the 3^{rd} straight portion (counting from upstream). The subsequent straight portions turn at the turn portions in the same manner as above, so that the flow channels 71 and 72 meander.

In each of the flow channels 71 and 72, the cross-sectional shape of the flow channel was rectangular, and the depth of the flow channel was constant at 1.0 mm from the starting end to the terminating end.

The lengths of the flow channels 71 and 72 in the upstream section were set equal to each other, the lengths of the flow channels 71 and 72 in the midstream section were set equal to each other, and the length of the flow channels 71 and 72 in the downstream section were set equal to each other. Specifically, in the flow channel 71, the upstream section was an portion extending from the end of the flow channel 71 near the fuel inlet 73 to the downstream-side end of the 5^{th} straight portion 711a (counting from upstream). The midstream section was an portion extending from the upstream-side end of a turn 712a in the 3^{rd} turn portion to the downstream-side end of the 9^{th} straight portion 711b (counting from upstream). The downstream section was an portion extending from the upstream-side end of a turn 712b in the 5^{th} turn portion to the end of the flow channel 71 near the fuel outlet 74.

In the flow channel 72, the upstream section was an portion extending from the end of the flow channel 72 near the fuel inlet 73 to the downstream-side end of the 6^{th} straight portion 721a (counting from upstream). The midstream section was an portion extending from the upstream-side end of a turn 722a in the 3^{rd} turn portion to the downstream-side end of the 10^{th} straight portion 721b (counting from upstream). The downstream section was an portion extending from the upstream-side end of a turn 722b in the 5^{th} turn portion to the end of the flow channel 72 near the fuel outlet 74.

In each of the flow channels 71 and 72, the width of the flow channel was set to 1.0 mm in the upstream section, 1.5 mm in the midstream section, and 2.0 mm in the downstream section. The perpendicular distance from the center of the width of one straight portion to the center of the width of the straight portion adjacent thereto was constant at 3.2 mm.

The total length A from the outside end of the 1^{st} straight portion parallel to the fuel flow direction to the outside end of the 14^{th} straight portion parallel to the fuel flow direction was 43.1 mm. The lengths B from the outside end of one turn portion to the outside end of the next turn portion were all 45 mm.

A direct oxidation fuel cell of Example 5 was produced in the same manner as in Example 1, except that the anode-side separator thus prepared was used.

The fuel cell thus produced was evaluated for power generation characteristics in the same manner as in Example 1. The results are shown in Table 1.

### Example 6

In the preparation of an anode-side separator in Example 1, the width of the fuel flow channel was set constant at 1.0 mm from the starting end to the terminating end, and the depth of the fuel flow channel was changed. Specifically, the portion extending from the fuel flow channel starting end to the 5^{th} straight portion was regarded as the upstream section, and the depth of the flow channel therein was set to 1.0 mm. The portion extending from the upstream-side end of the 5^{th} turn portion to the 10^{th} straight portion was regarded as the midstream section, and the depth of the flow channel therein was set to 1.5 mm. The portion extending from the upstream-side end of the 10^{th} turn portion to the flow channel terminating end was regarded as the downstream section, and the depth of the flow channel therein was set to 2.0 mm.

A direct oxidation fuel cell of Example 6 was produced in the same manner as in Example 1, except that the anode-side separator thus prepared was used.

The fuel cell thus produced was evaluated for power generation characteristics in the same manner as in Example 1. The results are shown in Table 1.

### Example 7

A direct oxidation fuel cell was produced in the same manner as in Example 1. The fuel cell was evaluated for power generation characteristics in the same manner as in Example 1, except that an aqueous 1 mol/L methanol solution was supplied to the fuel cell. The results are shown in Table 1.

### Comparative Example 1

In the preparation of an anode-side separator in Example 1, the width of the fuel flow channel was set constant at 1.5 mm from the starting end to the terminating end.

A direct oxidation fuel cell of Comparative Example 1 was produced in the same manner as in Example 1, except that the anode-side separator thus prepared was used.

The fuel cell thus produced was evaluated for power generation characteristics in the same manner as in Example 1. The results are shown in Table 1.

### Comparative Example 2

In the preparation of an anode-side separator, a parallel flow channel was formed. Specifically, the fuel flow channel was formed of a plurality of straight flow channels arranged in parallel with each other. The number of the straight flow channels was fifteen. The cross-sectional area of each straight flow channel was rectangular, and the depth of each flow channel was set constant at 1.0 mm.

The length of each straight flow channel from the starting end to the terminating end was 45 mm. Each straight flow channel was formed so as to have upstream, midstream and downstream sections having different cross-sectional areas. Specifically, in each straight flow channel, the portion extending 15 mm downstream from the starting end of the flow channel was regarded as the upstream section, and the width of the flow channel therein was set to 1.0 mm. The portion extending 15 mm downstream from the downstream-side end of the upstream section was regarded as the midstream section, and the width of the flow channel therein was set to 1.5 mm. The portion extending from the downstream-side end of the midstream section to the terminating end of the flow channel was regarded as the downstream section, and the width of the flow channel therein was set to 2.0 mm.

The distance from the center of the width of one straight flow channel to the center of the width of the straight flow channel adjacent thereto was constant at 3.0 mm. The total length from the outside end of the 1^{st} straight flow channel parallel to the fuel flow direction to the outside end of the 15^{th} straight channel parallel to the fuel flow direction was set to 43.5 mm.

A direct oxidation fuel cell of Comparative Example 2 was produced in the same manner as in Example 1, except that the anode-side separator thus prepared was used.

The fuel cell thus produced was evaluated for power generation characteristics in the same manner as in Example 1. The results are shown in Table 1.

### Comparative Example 3

A direct oxidation fuel cell was produced in the same manner as in Comparative Example 1. The fuel cell was evaluated for power generation characteristics in the same manner as in Example 1, except that an aqueous 1 mol/L methanol solution was supplied to the fuel cell. The results are shown in Table 1.

TABLE 1

| | | Cross-sectional area of fuel flow | | | | | | |
|---|---|---|---|---|---|---|---|---|
| | | channel (mm²) | | | | | | |
| | | Ratio relative to overall length | | | | | | |
| | | of flow channel | | | | | Average | |
| | Shape of fuel | Upstream | Midstream | | | Downstream | voltage | Fuel |
| | flow channel | section | section | | | section | (V) | efficiency |
| Ex. 1 | One serpentine | 1.0 | 1.5 | | | 2.0 | 0.46 | 0.85 |
| | channel | | | | | | | |
| | Constant depth | 1/3 | 1/3 | | | 1/3 | | |
| Ex. 2 | One serpentine | 1.0 | 1.5 | | | 2.0 | 0.45 | 0.83 |
| | channel | | | | | | | |
| | Constant depth | 1/5 | 7/15 | | | 1/3 | | |
| Ex. 3 | One serpentine | 1.0 | 1.5 | | | 2.0 | 0.43 | 0.87 |
| | channel | | | | | | | |
| | Constant depth | 1/2 | 1/4 | | | 1/4 | | |
| Ex. 4 | One serpentine | 1.0 | 1.2 | 1.5 | 1.8 | 2.0 | 0.47 | 0.84 |
| | channel | | | | | | | |
| | Constant depth | 1/5 | 1/5 | 1/5 | 1/5 | 1/5 | | |

| Ex. 5 | Two serpentine | 1.0 | 1.5 | 2.0 | 0.41 | 0.82 |
|---|---|---|---|---|---|---|
| | channels | | | | | |
| | Constant depth | 1/2 | 1/4 | 1/4 | | |
| Ex. 6 | One serpentine | 1.0 | 1.5 | 2.0 | 0.40 | 0.85 |
| | channel | | | | | |
| | Constant width | 1/3 | 1/3 | 1/3 | | |
| Ex. 7 | One serpentine | 1.0 | 1.5 | 2.0 | 0.42 | 0.90 |
| | channel | | | | | |
| | Constant depth | 1/3 | 1/3 | 1/3 | | |
| Com. | One serpentine | 1.5 | | | 0.37 | 0.72 |
| Ex. 1 | channel | | | | | |
| | Constant depth | 1/1 | | | | |
| Com. | Fifteen parallel | 1.0 | 1.5 | 2.0 | 0.32 | 0.76 |
| Ex. 2 | channels | | | | | |
| | Constant depth | 1/3 | 1/3 | 1/3 | | |

| | | | | |
|---|---|---|---|---|
| Com. | One serpentine | 1.5 | 0.40 | 0.84 |
| Ex. 3 | channel | | | |
| | Constant depth | 1/1 | | |

The fuel cells of Examples 1 to 6 in which the cross-sectional area of the anode-side separator was increased stepwise from upstream toward downstream along the fuel flow direction exhibited significant improvement in power generation characteristics and fuel efficiency, as compared with the fuel cell of Comparative Example 1 including an anode-side separator provided with a fuel flow channel having a constant cross-sectional area. These characteristics were improved, presumably because, in the fuel cells of Examples 1 to 6, MCO was reduced upstream of the fuel flow channel; and a sufficient amount of methanol was supplied downstream of the fuel flow channel.

Particularly in Example 3 in which the extent of the upstream fuel flow channel portion having a small cross-sectional area, relative to the overall length of the flow channel, was the largest, the power generation characteristics were not so good, but the fuel efficiency was the highest. This is presumably because the effect to reduce MCO was the strongest.

The fuel cell of Example 4 in which the width of the fuel flow channel was changed in multiple steps from upstream toward downstream exhibited the most excellent power generation characteristics. This is presumably because the effect to reduce MCO and the effect to supply methanol sufficiently were exerted adequately depending on the places where the fuel concentrations were different.

In Example 5 in which the fuel flow channel includes two independent serpentine flow channels arranged in parallel, the power generation characteristics and the fuel efficiency were slightly lower than in other Examples. One possible cause of this is that one of the two flow channels temporarily failed to allow the fuel to flow therethrough.

In the fuel cell of Example 6 in which not the width but the depth of the fuel flow channel was increased stepwise, the power generation characteristics were slightly lower than in other Examples. This is presumably because the width of the fuel flow channel was held constant and was small even on the downstream side of the fuel flow channel, and the methanol supply became slightly insufficient.

In Example 7 in which the width of the fuel flow channel was increased stepwise from upstream toward downstream along the fuel flow direction, and a low-concentration aqueous methanol solution was used as the fuel, the power generation characteristics were improved as compared with Comparative Example 3 also using a low-concentration aqueous methanol solution, but less improved than in Examples 1 to 6 using a high-concentration aqueous methanol solution. This is presumably because MCO occurring upstream of the fuel flow channel is usually not so severe when the methanol concentration is low as in Comparative Example 3. This result indicates that the present invention is more effective in reducing MCO, particularly when using a low-concentration aqueous methanol solution. Increasing the methanol concentration in the fuel can reduce the size of the fuel cell system.

The fuel cell of Comparative Example 2 in which the anode-side separator was provided with a parallel fuel flow channel exhibited the lowest power generation characteristics, even though the width of the fuel flow channel was increased stepwise from upstream toward downstream along the fuel flow direction. One possible cause of this is that, among many straight channels of the fuel flow channel, some channels frequently failed to allow the fuel to flow therethrough.

The foregoing results show that the fuel cell of the present invention has improved power generation characteristics and power generation efficiency.

### INDUSTRIAL APPLICABILITY

According to the present invention, an oxidation fuel cell having excellent power generation characteristics and power generation efficiency can be provided. Therefore, the present invention makes it possible to improve the performance of a fuel cell system. The direct oxidation fuel cell of the present invention is very useful as a power source for small devices such as cellular phones or notebook personal computers, and as a portable power generator.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1 Cell

10 Electrolyte membrane

11 Anode

12 Cathode

13 Membrane electrode assembly

14, 64, 70 Anode-side separator

15 Cathode-side separator

16 Anode catalyst layer

17 Anode diffusion layer

18 Cathode catalyst layer

19 Cathode diffusion layer

20, 60 Fuel flow channel

201, 601, 601a, 601b, 711, 721, 711a, 711b, 721a, 721b Straight portion

202, 602, 602a, 602b, 712, 722, 712a, 712b, 722a, 722b Turn portion

21 Oxidant flow channel

22, 23 Gasket

24, 25 Current collector plate

26, 27 Insulator plate

28, 29 End plate

30, 31 Heater

40, 71a, 72a Upstream section

41, 71b, 72b Midstream section

42, 71c, 72c Downstream section

43, 73 Fuel inlet

44, 74 Fuel outlet

40a, 41a, 42a Major region

40b, 41b, 41c, 42b, 63, 81, 65, 66 Communication region

50 Upstream unit

51 Midstream unit

52 Downstream unit

53, 54, 61, 62, 75, 76, 77, 78 Communication point

55 Entrance (Starting end of fuel flow channel)

56 Exit (Terminating end of fuel flow channel)

71, 72 Flow channel

1. A direct oxidation fuel cell using methanol or an aqueous methanol solution as a fuel, the direct oxidation fuel cell comprising at least one cell, each cell comprising a stack of: a membrane electrode assembly including an anode, a cathode, and an electrolyte membrane interposed between the anode and the cathode; an anode-side separator facing the anode; and a cathode-side separator facing the cathode, wherein
the anode-side separator has a serpentine fuel flow channel on a surface thereof facing the anode, the fuel is supplied from upstream of the fuel flow channel, and the serpentine fuel flow channel has a cross-sectional area that increases stepwise from upstream toward downstream of the fuel flow channel.

2. The direct oxidation fuel cell in accordance with claim 1, wherein the cross-sectional area increases at a turn portion of the serpentine fuel flow channel.

3. The direct oxidation fuel cell in accordance with claim 1, wherein the serpentine fuel flow channel comprises fuel flow paths having different cross-sectional shapes, the fuel flow paths being allowed to communicate with each other by arranging side by side at least two anode-side separator units provided with the fuel flow paths having different cross-sectional shapes, wherein
the fuel flow path of each of the anode-side separator units has a major region constituting a major part of the fuel flow path and having a constant cross-sectional shape, and a communication region provided continuously from at least one end of the major region, and
of the anode-side separator units adjacent to each other, cross-sectional areas of the major regions increase stepwise from upstream toward downstream of the fuel flow channel, and the communication regions connected to each other have an identical cross-sectional shape.

4. The direct oxidation fuel cell in accordance with claim 3, wherein the communication regions connected to each other of the anode-side separator units adjacent to each other are located at a turn portion of the serpentine fuel flow channel.

5. The direct oxidation fuel cell in accordance with claim 1, wherein a cross-sectional shape of the fuel flow channel is constant from a starting end of the fuel flow channel, from upstream toward downstream thereof, to an extent of one-fifth to one-half of an overall length of the fuel flow channel.

6. The direct oxidation fuel cell in accordance with claim 1, wherein at least part of the fuel flow channel comprises two or three independent serpentine flow channels, and the flow channels are arranged in parallel with each other.

7. The direct oxidation fuel cell in accordance with claim 1, wherein the aqueous methanol solution has a methanol concentration of 3 mol/L to 8 mol/L.
